(19) United States
(12) Patent Application Publication
(10) Pub. No.: US 2025/0363730 A1
(43) Pub. Date: Nov. 27, 2025

(54) ILLUMINATION MODIFICATION FOR DYNAMIC SCENE RELIGHTING

(71) Applicant: QUALCOMM Incorporated, San Diego, CA (US)

(72) Inventors: Shihao Shen, San Diego, CA (US); Varun Ravi Kumar, San Diego, CA (US); Louis Joseph Kerofsky, San Diego, CA (US); Senthil Kumar Yogamani, Headford (IE)

(21) Appl. No.: 18/674,276

(22) Filed: May 24, 2024

(51) Int. Cl. G06T 15/50; G06T 15/60; G06T 19/20

(52) U.S. Cl. CPC G06T 15/506; G06T 15/60; G06T 19/20; G06T 2219/2012

(57) ABSTRACT

A system comprises processors configured to generate rendered color data for a plurality of camera rays, and the processors are configured to: for each location in a 3-dimensional scene along the camera rays: apply static and transient heads of a trained ML model to location data to generate static and transient output data for a location; generate composite density data for the location based on static and transient density data for the location; and generate composite albedo data for the location; and generate the rendered color data for the camera ray based on shadow data, the composite density data, the composite albedo data, the static or transient normal vectors for the locations along the camera ray, and a set of spherical harmonics coefficients representing target illumination conditions; and generate a relit image based on the rendered color data for the plurality of camera rays.

### TECHNICAL FIELD

This disclosure relates to systems for image processing.

### BACKGROUND

Machine learning models may be used for various image processing tasks. These machine learning models are trained based on image data. Differences in the types of image data used for training may affect the abilities of machine learning models to function correctly. For example, a machine learning model training primarily on image data showing daytime scenes may have difficulty processing image data showing nighttime scenes.

### SUMMARY

In general, this disclosure describes techniques that modify illumination levels of 3-dimensional scenes. More specifically, a Neural Radiance Field (NeRF)-based machine learning (ML) model may be trained to disentangle shape data, reflectance data (i.e., albedo data), and illumination data from a scene. A computing system uses such data to render an image of the scene with new illumination parameters. Thus, the scene may be relit to simulate various lighting conditions while preserving the original geometry, albedo, and textures. The NeRF-based ML model may be trained to learn scene geometry in a way that is agnostic to lighting by decomposing scenes into shape, reflectance, and illumination. For instance, the NeRF-based ML model may be trained on images of the scene captured in daytime illumination conditions, but a relit image may show the scene in nighttime illumination conditions. Relighting the scene to nighttime illumination conditions in this way may avoid issues associated with noisy sensor measurements common in nighttime scenes. Because the scene may be relit, the images can be changed from daylight illumination conditions to nighttime illumination conditions, or vice versa. This allows the downstream perception tasks to have access to a wider variety of illumination conditions for training purposes or allow the downstream perception tasks to use images with consistent illumination conditions. The NeRF-based ML model of this disclosure may relight images in a more realistic way than existing techniques for changing the illumination of images because the NeRF-based ML model accounts for static and transient objects and learns scene geometry in a way that is agnostic to the original illumination conditions.

In one example, this disclosure describes a system comprising: a storage system configured to store a trained machine learning (ML) model; and a processing system comprising one or more processors implemented in circuitry and coupled to the storage system, the one or more processors configured to: generate rendered color data for a plurality of camera rays, wherein each of the camera rays is cast from a camera origin point in a respective direction, and the one or more processors are configured to, as part of generating the rendered color data: for each location of a plurality of locations in a 3-dimensional scene along each camera ray of the plurality of camera rays: apply a static head of the trained ML model to location data to generate static output data for the location, wherein the location data indicates the location and the static output data for the location includes a static albedo data for the location in an absence of any transient objects at the location, a static density data for the location in the absence of any transient objects at the location, and a static normal vector for the location in the absence of any transient objects at the location; apply a transient head of the trained ML model to the location data and a transient embedding to generate transient output data for transient objects at the location, wherein the transient output data for the location includes transient albedo data for the location at a specific point in time, transient density data for the location at the specific point in time, and a transient normal vector for the location at the specific point in time; apply a multilevel perceptron of the trained ML model to the location data and a set of Spherical Harmonics (SH) coefficients to generate shadow data for the location, the set of SH coefficients representing target illumination conditions for a relit image; generate composite density data for the location based on the static density data for the location and the transient density data for the location; and generate composite albedo data for the location based on the static albedo data for the location, the transient albedo data for the location, the static density data for the location, the transient density data for the location, and the composite density data for the location; and generate the rendered color data for the camera ray based on the shadow data for the locations along the camera ray, the composite density data for the locations along the camera ray, the composite albedo data for the locations along the camera ray, the static or transient normal vectors for the locations along the camera ray, and the SH coefficients; and generate the relit image based on the rendered color data for the plurality of camera rays.

In another example, this disclosure describes a computer-implemented method comprising: generating rendered color data for a plurality of camera rays, wherein each of the camera rays is cast from a camera origin point in a respective direction, and generating the rendered color data comprises: for each location of a plurality of locations in a 3-dimensional scene along each camera ray of the plurality of camera rays: applying a static head of a trained machine learning (ML) model to location data to generate static output data for the location, wherein the location data indicates the location and the static output data for the location includes a static albedo data for the location in an absence of any transient objects at the location, a static density data for the location in the absence of any transient objects at the location, and a static normal vector for the location in the absence of any transient objects at the location; applying a transient head of the trained ML model to the location data and a transient embedding to generate transient output data for the location, wherein the transient output data for the location includes transient albedo data for the location at a specific point in time, transient density data for the location at the specific point in time, and a transient normal vector for the location at the specific point in time; applying a multilevel perceptron of the trained ML model to the location and a set of Spherical Harmonics (SH) coefficients to generate shadow data for the location, the set of SH coefficients representing target illumination conditions for a relit image; generating composite density data for the location based on the static density data for the location and the transient density data for the location; and generating composite albedo data for the location based on the static albedo data for the location, the transient albedo data for the location, the static density data for the location, the transient density data for the location, and the composite density data for the location; and generating the rendered color data for the camera ray based on the shadow data for the locations along the camera ray, the composite density data for the locations along the camera ray, the composite albedo data for the locations along the camera ray, the static or transient normal vectors for the locations along the camera ray, and the set of SH coefficients; and generating the relit image based on the rendered color data for the plurality of camera rays.

In another example, this disclosure describes a system comprising: a storage system configured to store a trained ML model; and one or more processors implemented in circuitry and coupled to the storage system, the one or more processors configured to: train a machine learning (ML) model to generate rendered color data for a camera ray, wherein the one or more processors are configured to, as part of training the ML model, for each training example of a plurality of training examples: generate rendered color data for a plurality of camera rays, wherein each of the camera rays is cast from a camera origin point associated with the training example in a respective direction associated with the training example, and the one or more processors are configured to, as part of generating the rendered color data: for each location of a plurality of locations in a 3-dimensional scene along each camera ray of the plurality of camera rays: apply a static head of the ML model to location data to generate static output data for the location, wherein the location data indicates the location and the static output data for the location includes a static albedo data for the location in an absence of any transient objects at the location, a static density data for the location in the absence of any transient objects at the location, and a static normal vector for the location in the absence of any transient objects at the location; apply a transient head of the ML model to the location data and a transient embedding to generate transient output data for the location, wherein the transient output data for the location includes transient albedo data for the location at a specific point in time associated with the training example, transient density data for the location at the specific point in time, and a transient normal vector for the location at the specific point in time; apply a multilevel perceptron of the ML model to the location and a set of Spherical Harmonics (SH) coefficients to generate shadow data for the location, the set of SH coefficients representing illumination conditions of a ground-truth image associated with the training example; generate composite density data for the location based on the static density data for the location and the transient density data for the location; and generate composite albedo data for the location based on the static albedo data for the location, the transient albedo data for the location, the static density data for the location, the transient density data for the location, and the composite density data for the location; and generate the rendered color data for the camera ray based on the shadow data for the locations along the camera ray, the composite density data for the locations along the camera ray, the composite albedo data for the locations along the camera ray, the static or transient normal vectors for the locations along the camera ray, and the set of SH coefficients; and generate a rendered image based on the rendered color data for the plurality of camera rays; apply a photometric loss based on the rendered color data for the plurality of camera rays and color data of the ground-truth image associated with the training example; and perform a backpropagation process that modifies parameters of the ML model based on the photometric loss.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example system according to techniques of this disclosure.

FIG. 2 is a block diagram illustrating an example machine learning model of a relighting framework in accordance with one or more techniques of this disclosure.

FIG. 3 is a flowchart of an example operation in accordance with one or more techniques of this disclosure.

FIG. 4 is a flowchart of an example training operation in accordance with one or more techniques of this disclosure.

### DETAILED DESCRIPTION

The machine learning models that control autonomous and semi-autonomous vehicles are trained based on large amounts of image data captured by cameras mounted on other vehicles. Since most driving occurs during daytime hours, most of the image data shows daytime scenes. Thus, the machine learning models may become more adept at using image data showing daytime scenes than nighttime scenes. However, it may be equally important for autonomous and semi-autonomous vehicles to be able to operate at night. Machine learning models pretrained on image data showing daytime scenes may perform poorly when applied to image data showing nighttime scenes, due to a domain shift in lighting conditions. Similar considerations apply with respect foggy conditions. Furthermore, similar situations occur for perception tasks other than autonomous and semi-autonomous vehicles.

Existing approaches have tried to address this problem. For example, synthetic datasets may be used for training on target scenarios. However, there is a gap between simulated scenarios and real scenarios. In other words, simulated scenarios would not be able to capture enough of the scenarios that actually happen at night. In another example, it is observed that application of an off-the-shelf optical flow estimator to image data of nighttime scenes has poor performance. However, a domain adaptation approach is not scalable to different adverse conditions because for each new condition, a new set of exclusively designed augmentations to simulate the target domain may be required. Other perception tasks like semantic segmentation also use similar domain adaptation techniques. Applying brute force style-based editing, such as a day-to-night style transfer, to generate nighttime data may break realism and may even hurt performance as compared to no adaptation at all. This is in part because style transfer lacks physical understanding and edits appearances inconsistently, causing issues like uneven lighting within or across frames, or causing artifacts.

This disclosure describes techniques that may address problems related to the relative lack of image data showing nighttime scenes among other problems. Instead of trying to simulate nighttime scenarios either by domain adaptation or style transfer, the techniques of this disclosure disentangle lighting from scenes shown in image data, thereby making it possible to learn scene embeddings as if the image data showed daytime scenes. As such, downstream perception tasks can process the learned embeddings as from image data showing daytime scenes even though the image data originally showed nighttime scenes.

As described in this disclosure, a computing system may generate rendered color data for a plurality of camera rays. Each of the camera rays is cast from a camera origin point in a respective direction. As part of generating the rendered color data, for each location of a plurality of locations in a 3-dimensional scene along each camera ray of the plurality of camera rays, the computing system may apply a static head of a trained ML model to location data to generate static output data for the location. The location data indicates the location and the static output data for the location includes a static albedo data for the location in an absence of any transient objects at the location, a static density data for the location in the absence of any transient objects at the location, and a static normal vector for the location in the absence of any transient objects at the location. Additionally, the computing system may apply a transient head of the trained ML model to the location data and a transient embedding to generate transient output data for the location. The transient output data for the location includes transient albedo data for the location at a specific point in time, transient density data for the location at the specific point in time, and a transient normal vector for the location at the specific point in time. The computing system may apply a multilevel perceptron of the trained ML model to the location data and a set of Spherical Harmonics (SH) coefficients to generate shadow data for the location. The set of SH coefficients may represent target illumination conditions for a relit image. Additionally, the computing system may generate composite density data for the location based on the static density data for the location and the transient density data for the location. The computing system may generate composite albedo data for the location based on the static albedo data for the location, the transient albedo data for the location, the static density data for the location, the transient density data for the location, and the composite density data for the location. Furthermore, the computing system may generate the rendered color data for the camera ray based on the shadow data for the locations along the camera ray, the composite density data for the locations along the camera ray, the composite albedo data for the locations along the camera ray, the static or transient normal vectors for the locations along the camera ray, and the set of SH coefficients. The computing system may generate the relit image based on the rendered color data for the plurality of camera rays. In this way, the trained ML model may disentangle albedo data, shadow data, and density data (e.g., geometry data) from the scene and use this data to relight the scene using the SH coefficients. The computing system may change the illumination conditions shown in the relit image by using different SH coefficients. This may process may result in relit images that are more realistic or more suitable than images generated using conventional techniques.

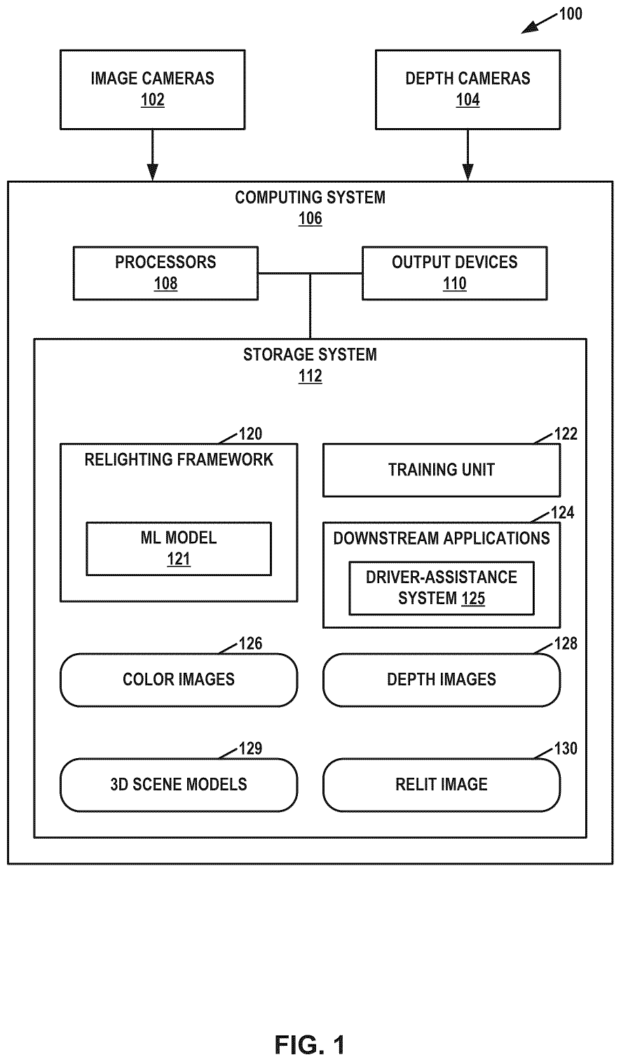

FIG. 1 is a block diagram illustrating an example system 100 according to techniques of this disclosure. In various examples, system 100 may be part of a vehicle, smartphone, mobile device, computing device, robot, or other type of device. In the example of FIG. 1, system 100 includes a plurality of image cameras 102, a plurality of depth cameras 104, and a computing system 106. Computing system 106 may include one or more computing devices, such as personal computers, chipsets, mobile devices, or other types of devices.

Image cameras 102 are configured to generate image data, such as Red-Green-Blue (RGB) images or images in other color spaces. Image cameras 102 may be positioned at various locations around system 100. For instance, in an example where system 100 is a vehicle, image cameras 102 may include two or more forward-facing image cameras, two or more rear-facing image cameras, and so on.

Depth cameras 104 are configured to generate depth images. Depth images represent the depths of objects. In some examples, there is a depth camera for each of image cameras 102. For instance, in an example where image cameras 102 include a left image camera and a right image camera, depth cameras 104 may include a left depth camera corresponding to the left image camera and a right depth camera corresponding to the right image camera. In other examples, there are multiple image cameras 102 and a single depth camera. Depth images generated by a depth camera may represent the depths of objects shown in images generated by an image camera corresponding to the depth camera.

In some examples, the depth images include point clouds. In some examples, computing system 106 generate point clouds based on depth images generated by depth cameras 104. A point cloud is a collection of points. Each point indicates a single location in an n-dimensional space, such as a three-dimensional space. For instance, a point may be specified by an x-coordinate, a y-coordinate, and a z-coordinate. In an autonomous or semi-autonomous navigation scenario or in scenarios involving driver-assistance systems, the points in the point cloud may correspond to points on surfaces of objects in a scene. A scene is a 3-dimensional area. Examples of scenes may include a town, city, neighborhood or other area.

In the example of FIG. 1, computing system 106 includes one or more processors 108, one or more output devices 110, and a storage system 112. Processors 108, output devices 110, and storage system 112 may be communicatively coupled. Processors 108 may be implemented in circuitry. Example types of processors 108 may include microprocessors, digital signal processors, application-specific integrated circuits (ASICs), and so on. Output devices 110 may include display screens, extended reality display devices, and other devices for displaying output. In some examples, such as examples involving robotics or autonomous driving, driver-assistance (e.g., semi-autonomous driving), output device 110 may include actuators to perform various physical actions. Storage system 112 may include one or more non-transitory computer-readable storage media. Example types of non-transitory computer-readable storage media may include random access memory (RAM) units, disk drives, and so on.

Processors 108, output device 110, and the computer-readable storage media of storage system 112 may be distributed among two or devices of computing system 106 or may be consolidated within a single device of computing system 106.

Storage system 112 may be configured to store various types of data and computer-readable instructions. In the example of FIG. 1, storage system 112 stores data and instructions associated with a relighting framework 120, a training unit 122, and one or more downstream applications 124. Additionally, storage system 112 may store color images 126 generated by image cameras 102. In some examples, color images 126 may include pairs of stereoscopic color images. In some examples, color images 126 may include 2-dimensional 360° images. Storage system 112 may also store depth images 128 generated by depth cameras 104. In some examples, computing system 106 does not include instructions associated with training unit 122 and/or downstream applications 124. In some examples, relighting framework 120 and training unit 122 are not present in the same computing system.

Processors 108 may execute instructions of relighting framework 120, training unit 122, and downstream applications 124. Execution of instructions associated with relighting framework 120, training unit 122, and downstream applications 124 may configure processors to perform the functionality ascribed in this disclosure to relighting framework 120, training unit 122, and downstream applications 124. Thus, when this disclosure indicates that relighting framework 120, training unit 122, or downstream applications 124 (or sub-units thereof) perform specific actions, this may be the result of processors 108 executing instructions associated with relighting framework 120, training unit 122, and downstream applications 124. In other examples, some or all actions described in this disclosure as being performed by relighting framework 120, training unit 122, or downstream applications 124 (or sub-units thereof) may be performed by special purpose circuitry.

In general, relighting framework 120 is configured to generate a relit image 130. Relit image 130 may be a 2-dimensional image of a scene from a specified viewpoint direction under specified illumination conditions. Relighting framework 120 includes a machine learning (ML) model 121. ML model 121 is trained to output rendered color data for a camera ray extending from the specified viewpoint under the specified illumination conditions. The specified illumination conditions may be different from the illumination conditions of color images 126 of the scene on which ML model 121 is trained. By applying ML model 121 for multiple camera rays extending from the specified viewpoint, relighting framework 120 may generate rendered color data for the camera rays. Relighting framework 120 may generate relit image 130 based on the rendered color data.

For example, relighting framework 120 may generate rendered color data for a plurality of camera rays. Each of the camera rays is cast from a camera origin point (i.e., a viewpoint) in a different respective direction. For each location of a plurality of locations in the 3-dimensional scene along each camera ray of the plurality of camera rays, relighting framework 120 may apply a static head of ML model 121 to location data to generate static output data for the location. The location data indicates the location and the static output data for the location includes a static albedo data for the location in an absence of any transient objects at the location, a static density data for the location in the absence of any transient objects at the location, and a static normal vector for the location in the absence of any transient objects at the location. Relighting framework 120 may apply a transient head of ML model 121 to the location data and a transient embedding to generate transient output data for the location. The transient output data for the location includes transient albedo data for the location at a specific point in time, transient density data for the location at the specific point in time, and a transient normal vector for the location at the specific point in time. Additionally, relighting framework 120 may apply a multilevel perceptron of ML model 121 to the location data and a set of spherical harmonics (SH) coefficients to generate shadow data for the location. The set of SH coefficients may represent target illumination conditions for relit image 130. Relighting framework 120 may generate composite density data for the location based on the static density data for the location and the transient density data for the location. Furthermore, relighting framework 120 may generate a composite albedo data for the location based on the static albedo data for the location, the transient albedo data for the location, the static density data for the location, the transient density data for the location, and the composite density data for the location. Relighting framework 120 may generate the rendered color data for the camera ray based on the shadow data for the locations along the camera ray, the composite density data for the locations along the camera ray, the composite albedo data for the locations along the camera ray, the static or transient normal vectors for the locations along the camera ray, and the set of SH coefficients. Relighting framework 120 may generate a relit image based on the rendered color data for the plurality of camera rays.

Downstream applications 124 may use relit image 130 for various purposes. For example, downstream applications 124 may use relit image 130 as training data for training a driver-assistance system 125, such as a semiautonomous navigation system, or an autonomous navigation system. For instance, a segmentation model of such a driver-assistance system or autonomous navigation system may be trained using relit images. In other examples, downstream applications 124 may use relit image 130 for other image processing or perception tasks.

Training unit 122 may perform one or more processes to train ML model 121 of relighting framework 120. Training unit 122 may train ML model 121 based on color images 126 and depth images 128. For example, training unit 122 may use color images 126 and depth images 128 captured at a specific time and from a specific location within the 3D scene to generate a 3D scene model for the 3D scene, such as a 3D voxel image or a 3-dimensional surface mesh. For example, color images 126 may initially be 2-dimensional images. Training unit 122 may convert the point clouds of depth images 128 to 3-dimensional surface meshes. Training unit 122 may map locations in color images 126 to apply color to corresponding locations in the 3-dimensional surface mesh. In some examples, training unit 122 may perform a rendering process to generate a scene model based on the colored 3D surface mesh. Training unit 122 may generate multiple 3D scene models 129 based on color images 126 and depth images 128 captured at different times and at different locations within the 3D scene. Because 3D scene models 129 are captured at different times, different 3D scene models of the same scene may or may not include transient objects, such as cars and people, but static objects would remain at the same locations. Furthermore, because the 3D scene models 129 are captured at different times and at different locations, the illumination conditions may be different in different 3D scene models.

Training unit 122 may generate a set of training examples based on 3D scene models 129. The training examples may be associated with a specific viewpoint and viewing direction and may be associated with a 2D ground-truth image generated from 3D scene models 129 for the specific viewpoint and viewing direction. Training unit 122 may perform a plurality of training iterations to train ML model 121. In each iteration of the iterative training process, training unit 122 may apply ML model 121 to generate a 2D image from a viewpoint and viewing direction associated with one of the training examples. Training unit 122 may then apply a loss function to the generated 2D image and a ground-truth image associated with the training example. Training unit 122 may then perform a backpropagation process that updates parameters of ML model 121 according to a gradient of the loss function. Training unit 122 may continue performing such iterations for multiple training examples. In this way, ML model 121 learns a function that maps locations, viewing directions, and illumination conditions to rendered color data of images.

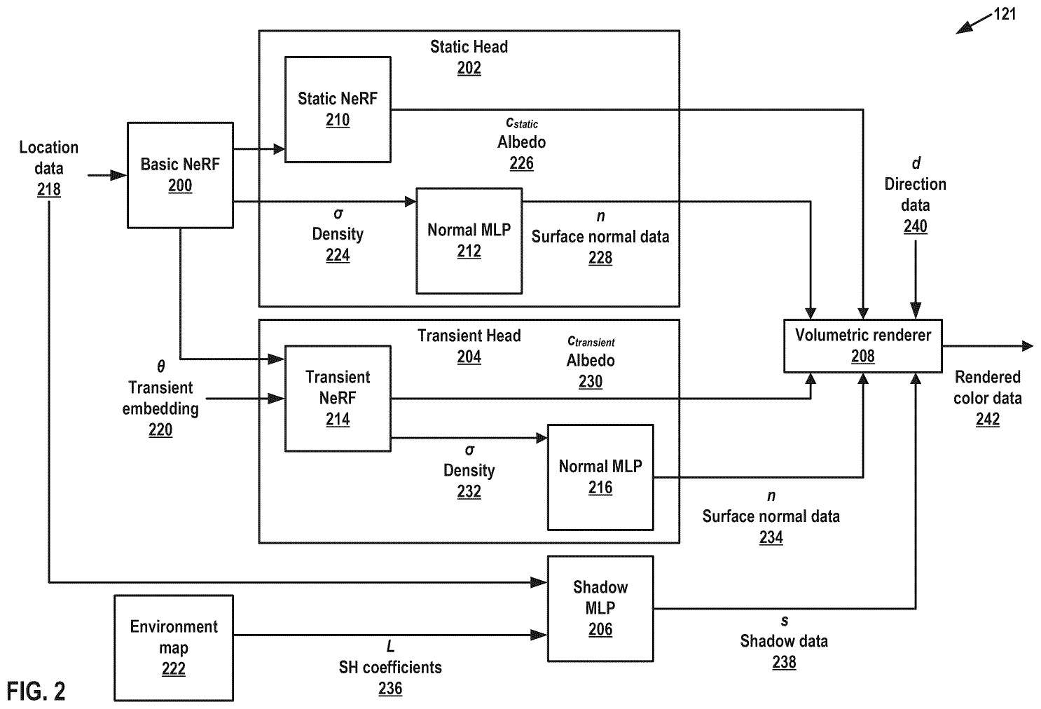

FIG. 2 is a block diagram illustrating an example ML model 121 of re-lighting framework 120 in accordance with one or more techniques of this disclosure. In the example of FIG. 2, ML model 121 includes a basic NeRF 200, a static head 202, a transient head 204, a shadow multi-layer perceptron (MLP) 206, and a volumetric renderer 208. Static head 202 includes a static NeRF 210 and a normal MLP 212. Transient head 204 includes a transient NeRF 214 and a normal MLP 216.

Relighting framework 120 receives location data 218 and viewing direction data 240 as input. Location data 218 specifies coordinates (e.g., XYZ coordinates, spherical coordinates, etc.) of a location within a scene. This disclosure uses the symbol x to represent a vector comprising location data 218. Viewing direction data 240 may include a vector specifying a direction in a 3-dimensional space from which the location indicated by location data 218 is viewed. This disclosure uses the symbol d to represent direction data 240. In some examples, direction data 240 includes elements indicating an elevation and an azimuth of the viewing direction.

Relighting framework 120 outputs rendered color data 242 for a camera ray. A camera ray is a conceptual straight line extending from a viewpoint (e.g., a camera location). Rendered color data 242 for a camera ray is based on the predicted densities, predicted colors, predicted normal vectors, predicted shadows, and illumination conditions of locations along the camera ray. Rendered color data 242 may include Red-Green-Blue (RGB) sample values, YCbCr sample values, or other types of sample values. Relighting framework 120 may repeat this process for multiple camera rays. Relighting framework 120 may compile the rendered color data for multiple camera rays to form relit image 130.

When generating a 2-dimensional relit image (e.g., relit image 130) that shows a portion of the scene from a particular viewpoint, relighting framework 120 generates color data for a plurality of camera rays. For each respective camera ray, relighting framework 120 provides the direction data 240 of the camera ray and location data 218 for a location along the camera ray as input to ML model 121. Relighting framework 120 repeats this for locations along the camera ray. Relighting framework 120 uses the resulting information for the locations along the camera ray, along with the direction data 240 for the camera ray to render color data for the camera ray. Relighting framework 120 uses the color data for the plurality of camera rays to generate the relit image. The location at which the camera rays in the plurality of camera rays converge is the viewpoint of the relit image. The plurality of camera rays may be limited to camera rays extending toward a specific area of the 3D scene. Thus, a center of this specific area is a viewing direction of the resulting 2D rendered image.

Relighting framework 120 includes static head 202 and transient head 204 due to the existence of static objects and transient object in scenes. Static objects may include objects whose absolute locations within a scene do not change. Examples of static objects may include buildings, traffic signs, roadways, road markings, trees, and so on. The absolute location of an object may be defined in a coordinate system of the scene. In contrast, transient objects may include objects whose absolute locations within a scene may change. Examples of transient objects include people, animals, parked or moving vehicles, road construction markers, and so on.

Basic NeRF 200 generates density data 224 based on location data 218. This disclosure uses the symbol ν to indicate density data, such as density data 224. Thus, basic NeRF 200 may be characterized as applying the implicit function σ=F_{σ}(x). The density data includes a density value for an individual location in the scene. The density value for a location is a measure of an ability of a material at the location to transmit light therethrough. For instance, the density value for a location in open air within the scene may be relatively low while the density value for a location on a surface of a building or roadway within the scene may be relatively high. Basic NeRF 200 is trained to learn the function σ=F_{σ}(x) for an individual scene. The density values are independent of any illumination conditions. By generating the density data, relighting framework 120 disentangles the geometry of the scene from images data used to train ML model 121.

Basic NeRF 200 may include a deep fully connected neural network without any convolutional layers. In other words, basic NeRF 200 may be implemented as a multilayer perceptron (MLP) that is trained to output density values for locations. In some examples, basic NeRF 200 includes 8 fully connected layers with 256 channels per layer and may use the Rectified Linear Unit (ReLU) activation function. The 8 fully connected layers may output a density value σ and a multi-dimensional feature vector. In some examples, the feature vector is a 256-dimensional feature vector. In other examples, other numbers of layers, other numbers of channels, and/or other activation functions may be used.

Static NeRF 210 of static head 202 generates albedo data 226 for the location indicated by location data 218 based on the feature vector generated by basic NeRF 200.

This disclosure uses the symbol c to indicate albedo data generally and uses the symbol c_{static} to indicate albedo data 226 generated by static head 202. Thus, static NeRF 210 may be characterized as applying the implicit function c_{static}=F_{c}(x). Albedo data 226 includes an albedo value for the location within the scene indicated by location data 218. The albedo value for the location indicates a proportion of incident light that reflects from a surface corresponding to the location. The albedo value of the location is independent of the brightness of the incident light. Thus, the albedo value of the location may be the same regardless of the illumination level or direction. By generating the albedo data, relighting framework 120 disentangles the albedo data from image data used to train ML model 121.

Static NeRF 210 may include one or more fully connected layers of artificial neurons which may use a ReLU activation function or other activation function. The one or more layers may map the multi-dimensional feature vector generated by basic NeRF 200 and viewing direction data 240 to single-dimensional albedo data 226.

Normal MLP 212 of static head 202 generates surface normal data 228 based on density data 224 (i.e., the multi-dimensional feature vector) generated by basic NeRF 200. This disclosure uses the symbol n to indicate surface normal data, such as surface normal data 228. Thus, normal MLP 216 may be characterized as applying the implicit function n=Fₙ(σ). The surface normal data includes a normal vector for the location in the scene indicated by location data 218. The normal vector for a location is a vector that is normal to a surface that includes the location. Normal MLP 212 may be implemented as a set of one or more fully connected layers of artificial neurons with a ReLU or other activation function. In this way, relighting framework 120 may apply static head 202 of ML model 121 to location data 218 to generate static output data for the location, where the static output data for the location includes albedo data for the location in the absence of any transient objects at the location, a static density data for the location in the absence of any transient objects at the location, and a static normal vector for the location in the absence of any transient objects at the location.

Transient NeRF 214 receives a transient embedding data 220 and the feature vector generated by basic NeRF 200 as input. This disclosure uses the symbol θ to indicate transient embedding data, such as transient embedding data 220. Transient embedding data 220 may comprise data distinguishing static objects and transient objects. There may be different sets of transient embedding data 220 for different points in time. Transient embedding data 220 includes parameters that are trained during a training process of machine learning model 121.

Transient NeRF 214 includes one or more fully connected layers of artificial neurons. Prior to providing transient embedding data 220 as input to transient NeRF 214, relighting framework 120 may modify transient embedding data 220 to increase the dimensionality of transient embedding data 220. This modification may include increasing spatial resolution, denoising or other pre-processing to complete and clean up the data. The one or more layers may map the modified transient embedding data 220 and the feature vector generated by basic NeRF 200 to single-dimensional albedo data 230 and to density data 232. This disclosure uses the symbol cₜᵣₐₙₛᵢₑₙₜ to represent albedo data 230 generated by transient head 204.

Normal MLP 216 of transient head 204 generates surface normal data 234 based on density data 232. Surface normal data 234 includes a transient normal vector for the location. In other words, the output of normal MLP 216 may be represented as n=Fₙ(σ). Normal MLP 216 may be implemented as a set of one or more fully connected layers of artificial neurons with a ReLU or other activation function.

As discussed elsewhere in this disclosure, training unit 122 may generate individual 3D scene models 129 based on color images 126 and depth images 128 captured at different times. Thus, 3D scene models 129 may include 3D scene models corresponding to different points in time. Therefore, training examples based on 3D scene models 129 may correspond to the different points in time. The 3D scene models 129 may contain transient objects at different positions at the different points in time. For instance, a 3D scene model based on images captured at a first time may show a car parked in a specific location and a 3D scene model based on images captured at a second time may not show any car parked in the specific location. Since basic NeRF 200 and static NeRF 210 do not take transient embeddings as input, the tendency of basic NeRF 200 and static NeRF 210 is to generate density data and albedo data that ignore transient objects because the transient objects are not present in ground-truth images of training examples generated from 3D scene models that correspond to different points in time. Thus, the static output data generated by static head 202 for the location includes a static albedo data for the location in an absence of any transient objects at the location, a static density data for the location in the absence of any transient objects at the location, and a static normal vector for the location in the absence of any transient objects at the location.

However, transient NeRF 214 is dependent on transient embedding data 220, which is specific to a point in time. Thus, when training unit 122 trains ML model 121 using training examples corresponding to a specific point in time, a backpropagation process performed by training unit 122 updates the transient embedding for that specific point in time. When relighting framework 120 generates a relit image of the scene, as the scene appeared at a specific point in time, relighting framework 120 may use the transient embedding corresponding to the specific point in time as input to transient NeRF 214. Thus, the transient output data generated by transient head 204 for the location includes transient albedo data for the location at the specific point in time, transient density data for the location at the specific point in time, and a transient normal vector for the location at the specific point in time.

Environment map 222 may represent a 2-dimensional pixel image of a 360° environment. In other words, environment map 222 is a 2-dimensional image of what a viewer would see if the viewer rotated 360°. Relighting framework 120 may use environment map 222 to determine spherical harmonics (SH) coefficients 236 that represent lighting within the scene. Relighting framework 120 may estimate SH coefficients 236 based on environment map 222 by using a least squares method.

Relighting framework 120 may determine SH coefficients 236 based on target illumination conditions of the relit image. For instance, if the relit image is to show a view of the scene with a nighttime level of illumination, relighting framework 120 may determine SH coefficients 236 corresponding to the nighttime level of illumination. Similarly, if the relit image is to show a view of the scene in a daytime level of illumination when the sun is at a specific location, relighting framework 120 may determine SH coefficients 236 corresponding to the daytime level of illumination and the sun is at the specific location. Relighting framework 120 may use environment map 222 as a basis for determining SH coefficients 236. Thus, by providing an environment map 222 showing the illumination conditions consistent with the target illumination conditions of the relit image, relighting framework 120 may determine SH coefficients that are used to relight the scene according to the target illumination conditions. During training of ML model 121 based on a training example, the SH coefficients may represent the illumination conditions of the ground-truth image of the training example.

Shadow MLP 206 receives SH coefficients 236 and location data 218 as input. This disclosure uses the symbol L to indicate SH data, such as SH coefficients 236. Shadow MLP 206 generates shadow data 238 for the location. This disclosure uses the symbol s to represent shadow data for a location. Thus, shadow MLP 206 may be characterized as applying the implicit function s=Fₛ(x, L). The shadow data for a location may indicate a degree to which illumination from an illumination source defined by the SH data is blocked at the location. In some examples, the shadow data for a location x is in a range of 0 to 1, inclusive (i.e., Fₛ(x, L)∈[0,1]). Shadow data of 1 may indicate that the none of the illumination from the illumination source is blocked. Shadow data of 0 may indicate that all of the illumination from the illumination source is blocked.

Shadow MLP 206 may include an input layer, one or more hidden layers, and an output layer. Neurons of the layers are fully connected. Shadow MLP 206 uses sigmoid activation function, a ReLU activation function, or another type of activation function. The input layer may include a neuron for each of the SH coefficients and a neuron for each of the X, Y, and Z coordinate values of the location. Because training unit 122 trains ML model 121 (and therefore shadow MLP 206) using training examples associated with ground-truth images having different illumination conditions (and therefore different SH coefficients), shadow MLP 206 learns to predict shadow data for different locations under different illumination conditions.

Volumetric renderer 208 receives static albedo data 226, static surface normal data 228, transient albedo data 230, transient surface normal data 234, shadow data 238, direction data 240, and SH coefficients 236 as input. Volumetric renderer 208 generates rendered color data 242 for a camera ray based on these inputs and corresponding data for other locations along the camera ray. Rendered color data 242 may include Red-Green-Blue (RGB) image data, Y-Cb-Cr image data, or image data in another color format. This disclosure uses the expression Ĉ(r, L) to represent rendered color data 242 corresponding to a camera ray having a direction vector r and a set of SH coefficients L. The SH coefficients L may be different from SH coefficients of training examples used to train ML model 121. By providing different SH coefficients 236, relighting framework 120 may relight the scene in different ways.

As part of generating rendered color data 242, volumetric renderer 208 may generate a composite density value for an individual location along the camera ray r based on the static density value for the location and the transient density value for the location, e.g., as described in equation (1), below:

$$σ = {σ}_{static} + {σ}_{transient} \qquad ( 1 )$$

Volumetric renderer 208 may generate a composite albedo value c for an individual location along the camera ray r based on the static albedo value for the location and the transient albedo value for the location, e.g., as described in equation (2), below:

$$c = \frac{{σ}_{static}}{σ} {c}_{static} + \frac{{σ}_{transient}}{σ} {c}_{transient} \qquad ( 2 )$$

In a typical NeRF, a final color of a camera ray is obtained by integrating densities and colors of all locations along a camera ray r, e.g., using the following volumetric rendering equation:

$$\hat{C} ( r ) = {\sum }_{i = 0}^{N - 1} {T}_{i} ( 1 - exp ( - {σ}_{i} {δ}_{i} ) ) {c}_{i} \qquad ( 3 )$$

In the volumetric rendering equation above,

$${T}_{i} = exp ( - {\sum }_{j = 0}^{i - 1} {σ}_{j} {δ}_{j} )$$

is an accumulated transmittance value for locations along the camera ray. The term δᵢ is the distance between locations along the camera ray r. For instance, δᵢ may indicate the physical distance in the scene between the centers of two pixels representing locations within the scene. The exp(x) function is the exponential function e^{x}, where e is Euler's number. The term N indicates a quantity of locations sampled along the camera ray r. The accumulated transmittance value for a location along the camera ray may indicate a probability that the camera ray travels from the origin point of camera ray r to the location without hitting any other particle.

Using SH coefficients L to represent target lighting conditions, the volumetric rendering equation above can be rewritten as:

$$\hat{C} ( r , L ) = {\sum }_{i = 0}^{N - 1} {T}_{i} ( 1 - exp ( - {σ}_{i} {δ}_{i} ) ) {c}_{i} ∘ L \cdot e ( n ) \qquad ( 4 )$$

In the volumetric rendering equation above, n is an estimated normal vector (e.g., the static normal vector or the transient normal vector) at a location where the camera ray r hits a surface, e(n) is a spherical harmonics basis of the estimated normal vector, and ∘ represents a Hadamard product. The estimated normal vector may be parameterized as

$$\vec{ω} = ( sin θ cos ϕ , sin θsinϕ , cos θ )$$

The spherical harmonic basis functions may be defined as:

$${y}_{l}^{m} ( θ , ϕ ) = \{ \begin{matrix}\sqrt{2} {K}_{l}^{m} cos ( m ϕ ) {P}_{l}^{m} ( cos θ ) if m > 0 , \\ {K}_{l}^{0} {P}_{l}^{0} ( cos θ ) if m = 0 \\ \sqrt{2} {K}_{l}^{m} sin ( - m ϕ ) {P}_{l}^{- m} ( cos θ ) if m < 0\end{matrix}$$

where

$${K}_{l}^{m}$$

are normalization constants,

$${K}_{l}^{m} = \sqrt{\frac{( 2 l + 1 )}{4 π} \frac{( l - \vert m \vert ) !}{( l + \vert m \vert ) !}}$$

and

$${P}_{l}^{m}$$

are the associated Legendre polynomials.

In accordance with a technique of this disclosure, the volumetric rendering equation may be further extended to render shadows based on shadow data 238 generated by shadow MLP 206, as follows:

$$\hat{C} ( r , L ) = {\sum }_{i = 0}^{N - 1} {T}_{i} ( 1 - exp ( - {σ}_{i} {δ}_{i} ) ) {s}_{i} \cdot {\sum }_{i = 0}^{N - 1} {T}_{i} ( 1 - exp ( - {σ}_{i} {δ}_{i} ) ) {c}_{i} ∘ {L}^{′} \cdot e ( n ) \qquad ( 5 )$$

Thus, volumetric renderer 208 may calculate shadow data for the location as the accumulated transmittance value for the location (i.e., Tᵢ(1-exp (−σᵢδᵢ))) multiplied by the shadow data for the location (i.e., sᵢ). Volumetric renderer 208 may calculate preliminary color data for the location as the accumulated transmittance value for the location multiplied by the composite albedo value for the location. Additionally, volumetric renderer 208 calculates illumination-adjusted color data for the location based on a Hadamard multiplication of the preliminary color data for the location (i.e., cᵢ) and a multiplication product of the SH coefficients representing a target illumination (i.e., L′) and the SH basis for the estimated normal vector for the camera ray. Volumetric renderer 208 may calculate shadow data for the camera ray as a sum of the shadow data for the locations along the camera ray

$$( i . e . , {\sum }_{i = 0}^{N - 1} {T}_{i} ( 1 - exp ( - {σ}_{i} {δ}_{i} ) ) {s}_{i} ) .$$

Volumetric renderer 208 may calculate a preliminary color data for the camera ray as a sum of the illumination-adjusted color data for the locations along the camera ray

$$( i . e . , ( {\sum }_{i = 0}^{N - 1} {T}_{i} ( 1 - exp ( - {σ}_{i} {δ}_{i} ) ) {c}_{i} ∘ {L}^{′} \cdot e ( n ) ) .$$

Volumetric renderer 208 may generate the rendered color data for the camera ray (i.e., Ĉ(r, L′)) as a multiplication product of the shadow data for the camera ray and the preliminary color data for the camera ray.

Relighting framework 120 may relight the scene by providing different SH coefficients L into the equation above. Thus, relighting framework 120 may relight the scene without modifying the encoded geometry F_{σ}, Fₙ, or materials F_{c}. This may provide options for integrating relighting framework 120 with downstream applications 124, such as downstream perception models. For example, the downstream perception models may be fine-tuned so that the downstream perception models are adapted to lighting-agnostic embeddings (i.e., the static and transient albedo data, the static and transient surface normal data, and the shadow data) learned by ML model 121. During inference, given noisy sensor measurements at night, the trained ML model 121 may produce lighting-agnostic scene embeddings first, and any downstream perception models can use the lighting-agnostic scene embeddings directly as input instead of encoding raw sensor measurements.

In some examples, computing system 106 may use relit images as input to downstream applications 124, such as pretrained perception models. This approach may improve completeness of downstream perception models because this approach uses available images and no longer requires fine tuning of the downstream perception models for different illumination conditions. During inference, given noisy sensor measurements at night, because trained ML model 121 will disentangle the scene into appearance, geometry, and lighting, relighting framework 120 may output daytime renderings by changing SH coefficients to daytime illumination conditions. As such, the appearance and geometry of the scene will remain the same as in sensor measurements, whereas the lighting now becomes daytime so that relit images generated by relighting framework 120 may be used as input to downstream applications 124.

Training unit 122 may train relighting framework 120 using supervised learning. For example, training unit 122 may calculate a square error photometric loss £ based on the output of relighting framework 120 (e.g., relit image 130). Training unit 122 may optimize the transient embedding θ alongside the parameters of each of the MLPs (i.e., basic NeRF 200, static NeRF 210, normal MLP 212, transient NeRF 214, normal MLP 212, and shadow MLP 206). In other words, training unit 122 adjusts the parameters in transient embedding data 220 according to a gradient of a loss function along with parameters of the neural networks in ML model 121. As discussed above, training unit 122 may optimize different transient embeddings for different points in time. Relighting framework 120 learns the decomposition of the scene into albedo, density, surface normal, and shadow through this loss [symbol] , e.g., using the following equation.

$$ℒ = {\sum }_{r ∈ R} {‖ \hat{C} ( r ) - {C}_{gt} ( r ) ‖}_{2}^{2} \qquad ( 6 )$$

In the equation above, Ĉ(r) is a final rendered color data of a camera ray r produced by relighting framework 120 as part of rendered image data 242. C_{gr}® is color data of the camera ray r in a ground-truth image associated with a training example. R indicates a set of camera rays, such as the set of camera rays used to generate relit image 130. The operator ∥ ∥₂ denotes a Euclidean norm. Thus, [symbol] represents a sum of square error photometric loss. Training unit 122 may use [symbol] in a backpropagation process to update the weights of the neural networks of relighting framework 120 and transient embedding data 220 for a point in time associated with the training example.

In some examples, downstream applications 124 may use one or more of static albedo data 226, static normal data 228, transient albedo data 230, transient normal data 234, or shadow data 238 for downstream tasks, such as object detection or segmentation, without using (or in addition to using) rendered image data 242.

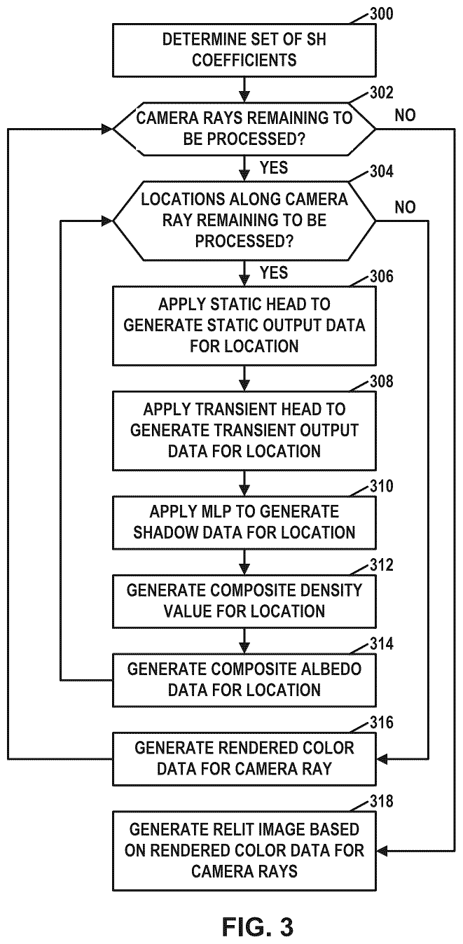

FIG. 3 is a flowchart illustrating an example operation for generating a relit image in accordance with one or more techniques of this disclosure. In the example of FIG. 3, relighting framework 120 may determine a set of SH coefficients (300). The set of SH coefficients may represent target illumination conditions model for the relit image. In other words, the SH coefficients may represent a set of illumination conditions, such as an illumination intensity and an illumination direction, to be used in the relit image. In some examples, relighting framework 120 may obtain the set of SH coefficients from a separate device. In some examples, relighting framework 120 determines the set of SH coefficients based on an environment map.

Additionally, relighting framework 120 may determine whether there are any camera rays in a plurality of camera rays remaining to be processed (302). The plurality of camera rays may converge at a viewpoint for the relit image. Relighting framework 120 may select the directions of camera rays based on a specified viewing direction for the relit image. If there are one or more camera rays in the plurality of camera rays remaining to be processed (“YES” branch of 302), relighting framework 120 may determine whether there are one or more locations in a scene that are along the camera ray remaining to be processed (304).

If there are one or more locations along the camera ray remaining to be processed (“YES” branch of 304), relighting framework 120 may apply a static head 202 of trained ML model 121 to location data to generate static output data for the location (306). The location data (e.g., location data 218) indicates the location. The static output data for the location may include a static albedo data for the location in the absence of any transient objects at the location, a static density data for the location in the absence of any transient objects at the location, a static normal vector for the location in the absence of any transient objects at the location. In some examples, ML model 121 has been trained using image data representative of the 3-dimensional scene. In some examples, relighting framework 120 applies a first NeRF model (e.g., basic NeRF 200) to the location data to generate a feature vector for the location and first density data for the location. As part of applying static head 202 of ML model 121, relighting framework 120 may apply a second NeRF model (e.g., static NeRF 210) to the feature vector for the location and the first density data for the location to generate the static albedo data for the location. Additionally, as part of applying static head 202 of ML model 121, relighting framework 120 may apply a first MLP (e.g., normal MLP 212) to the first density data for the location to generate the static normal vector for the location.

Additionally, relighting framework 120 may apply a transient head 204 of trained ML model 121 to the location data and a transient embedding to generate transient output data for the location (308). The transient output data for the location includes transient albedo data for the location at a specific point in time, transient density data for the location at the specific point in time, and a transient normal vector for the location at the specific point in time. In some examples, relighting framework 120 applies the static head 202 of ML model 121 and the transient head 204 of ML model 121 in parallel. As part of applying transient head 204 of ML model 121, relighting framework 120 may apply a third NeRF model (e.g., transient NeRF 214) to the feature vector for the location and transient embedding data 220 for the specific point in time to generate the transient albedo data for the location and the transient density data for the location. Additionally, as part of applying transient head 204 of ML model 121, relighting framework 120 may apply a second MLP (e.g., normal MLP 216) to the transient density data for the location to generate the transient normal vector for the location.

Relighting framework 120 may also apply a multilevel perceptron (e.g., shadow MLP 206) of trained ML model 121 to the location and the set of SH coefficients to generate shadow data for the location (310).

Relighting framework 120 may generate composite density data for the location based on the static density data for the location and the transient density data for the location (312), e.g., using equation (1) above. Furthermore, relighting framework 120 may generate a composite albedo data for the location based on the static albedo data for the location, the transient albedo data for the location, the static density data for the location, the transient density data for the location, and the composite density data for the location (314), e.g., using equation (2) above. After generating the composite albedo data for the location, relighting framework 120 may again determine whether there are one or more locations along the camera ray remaining to be processed (304).

If there are no locations along the camera ray remaining to be processed (“NO” branch of 304), relighting framework 120 may generate the rendered color data for the camera ray based on the shadow data for the locations along the camera ray, the composite density data for the locations along the camera ray, the composite albedo data for the locations along the camera ray, the static or transient normal vectors for the locations along the camera ray, and the set of SH coefficients (316). Relighting framework 120 may then determine again whether there are any camera rays remaining to be processed. (302).

Relighting framework 120 may use equation (5) to generate the rendered color data. For example, relighting framework 120 may calculate a transmittance value for the location based on the composite density data for the location and composite density data for previous locations along the camera ray and based on a distance between the locations along the camera ray. Relighting framework 120 may calculate shadow data for the camera ray based on the transmittance values for the locations along the camera ray and the shadow data for the locations along the camera ray. Additionally, relighting framework 120 may calculate a Spherical Harmonics basis based on the static normal vector and the transient normal vector. Relighting framework 120 may calculate preliminary color data for the camera ray based on the transmittance values for the locations along the camera ray, the composite albedo data for the locations along the camera ray, the set of SH coefficients, and the SH basis. In some examples, as part of calculating the preliminary color data for the camera ray, relighting framework 120 may calculate the preliminary color data for the camera ray as a sum of elements corresponding to the locations along the camera ray, each of the elements being a Hadamard multiplication of transmittance-adjusted color data for the location corresponding to the element and a multiplication product of the set of SH coefficients and the SH basis, the transmittance-adjusted color data for the location corresponding to the element being based on the transmittance value for the location corresponding to the element and the composite albedo data for the location. Relighting framework 120 may calculate the rendered color data for the camera ray based on the shadow data for the camera ray and the preliminary color data of the camera ray. For instance, relighting framework 120 may generate the rendered color data for the camera ray as a multiplication product of the shadow data for the camera ray and the preliminary color data for the camera ray.

If there are no camera rays remaining to be processed (“NO” branch of 302), relighting framework 120 may generate a relit image based on the rendered color data for the plurality of camera rays (318). For example, relighting framework 120 may compile the rendered color data for the plurality of camera rays to form the relit image. In some examples, relighting framework 120 may apply one or more filters to the compiled rendered color data to improve one or more aspects of the relit image.

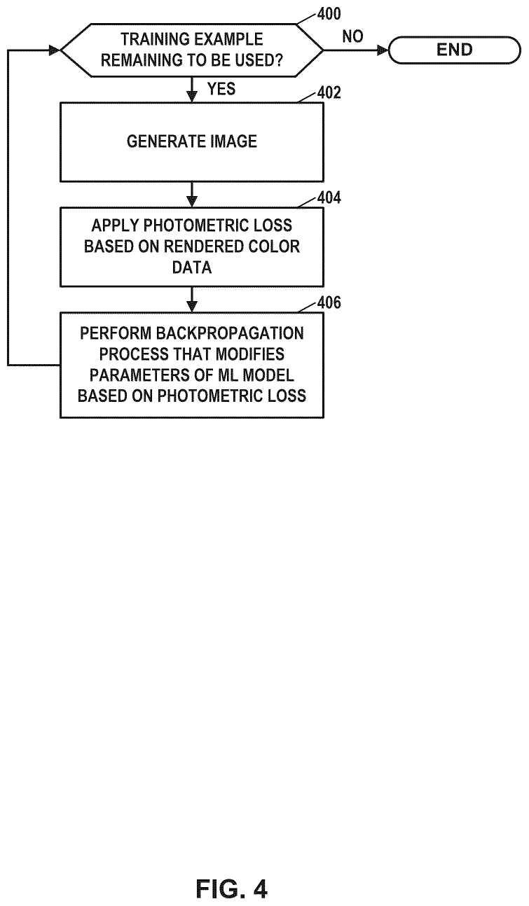

Although the example of FIG. 4 describes a process in which camera rays and locations are processed sequentially, relighting framework 120 may, in some examples, process many camera rays and locations in parallel.

FIG. 4 is a flowchart of an example training operation in accordance with one or more techniques of this disclosure. In the example of FIG. 4, training unit 122 may train a ML model 121 to generate rendered color data for a camera ray. As part of training ML model 121, training unit 122 may determine whether there are training examples in a plurality of training examples remaining to be used (400). Different training examples may be associated with ground truth images of a scene from different viewpoints, viewing directions, and points in time. Furthermore, each of the training examples may be associated with a set of SH coefficients representing illumination conditions of the ground-truth image associated with the training example. For instance, as described above, training unit 122 may generate one or more 3D scene models (e.g., 3D voxel models, 3D mesh models, etc.) based on color images and/or depth images captured at specific points in time and locations within the 3D scene. Training unit 122 may calculate SH coefficients representing the illumination conditions of the 3D scene models using a least squares method.

If there is a training example remaining to be used (“YES” branch of 400), training unit 122 may generate an image for the viewpoint, viewing direction, and point in time associated with the training example (402). To generate the image, training unit 122 may perform the process described above with respect to FIG. 3. When performing the process of FIG. 3, training unit 122 may use the SH coefficients associated with the training example as SH coefficients 236.

Training unit 122 may apply a photometric loss based on the generated image and the ground-truth image associated with the training example (404). Training unit 122 may then perform a backpropagation process that modifies parameters of ML model 121 based on the photometric loss (406). The backpropagation process may update parameters of Basic NeRF 200, shadow MLP 206, static NeRF 210, normal MLP 212, a transient NeRF 214, and normal MLP 216. Additionally, the backpropagation process may update a transient embedding for the point in time associated with the training example. Training unit 122 may then determine again whether there are training examples remaining to be used (400). If there are no training examples remaining to be used (“NO” branch of 400), training unit 122 may end the training process. In some examples, training unit 122 may continue training ML model 121, reusing one or more of the training examples.

In some examples, after at least partially completing the training process, training unit 122 may test ML model 121. During testing, training unit 122 may keep the parameters of all MLPs of ML model 121 fixed but only change the input environment map or directly control the SH coefficients, to relight the scene.

Various examples of the techniques of this disclosure are summarized in the following clauses.

Clause 1. A system comprising: a storage system configured to store a trained machine learning (ML) model; and a processing system comprising one or more processors implemented in circuitry and coupled to the storage system, the one or more processors configured to: generate rendered color data for a plurality of camera rays, wherein each of the camera rays is cast from a camera origin point in a respective direction, and the one or more processors are configured to, as part of generating the rendered color data: for each location of a plurality of locations in a 3-dimensional scene along each camera ray of the plurality of camera rays: apply a static head of the trained ML model to location data to generate static output data for the location, wherein the location data indicates the location and the static output data for the location includes a static albedo data for the location in an absence of any transient objects at the location, a static density data for the location in the absence of any transient objects at the location, and a static normal vector for the location in the absence of any transient objects at the location; apply a transient head of the trained ML model to the location data and a transient embedding to generate transient output data for transient objects at the location, wherein the transient output data for the location includes transient albedo data for the location at a specific point in time, transient density data for the location at the specific point in time, and a transient normal vector for the location at the specific point in time; apply a multilevel perceptron of the trained ML model to the location data and a set of Spherical Harmonics (SH) coefficients to generate shadow data for the location, the set of SH coefficients representing target illumination conditions for a relit image; generate composite density data for the location based on the static density data for the location and the transient density data for the location; and generate composite albedo data for the location based on the static albedo data for the location, the transient albedo data for the location, the static density data for the location, the transient density data for the location, and the composite density data for the location; and generate the rendered color data for the camera ray based on the shadow data for the locations along the camera ray, the composite density data for the locations along the camera ray, the composite albedo data for the locations along the camera ray, the static or transient normal vectors for the locations along the camera ray, and the SH coefficients; and generate the relit image based on the rendered color data for the plurality of camera rays.

Clause 2. The system of clause 1, wherein the one or more processors are configured to, as part of generating the rendered color data for the camera ray: calculate a transmittance value for the location based on the composite density data for the location and composite density data for previous locations along the camera ray and based on a distance between the locations along the camera ray; calculate shadow data for the camera ray based on the transmittance values for the locations along the camera ray and the shadow data for the locations along the camera ray; calculate a SH basis based on the static normal vector and the transient normal vector; calculate preliminary color data for the camera ray based on the transmittance values for the locations along the camera ray, the composite albedo data for the locations along the camera ray, the set of SH coefficients, and the SH basis; and calculate the rendered color data for the camera ray based on the shadow data for the camera ray and the preliminary color data for the camera ray.

Clause 3. The system of clause 2, wherein the one or more processors are configured to, as part of calculating the preliminary color data for the camera ray, calculate the preliminary color data for the camera ray as a sum of elements corresponding to the locations along the camera ray, each of the elements being a Hadamard multiplication of transmittance-adjusted color data for the location corresponding to the element and a multiplication product of the set of SH coefficients and the SH basis, the transmittance-adjusted color data for the location corresponding to the element being based on the transmittance value for the location corresponding to the element and the composite albedo data for the location.

Clause 4. The system of any of clauses 2-3, wherein the one or more processors are configured to generate the rendered color data for the camera ray as a multiplication product of the shadow data for the camera ray and the preliminary color data for the camera ray.

Clause 5. The system of any of clauses 1-4, wherein the trained ML model has been trained using image data representative of the 3-dimensional scene.

Clause 6. The system of any of clauses 1-5, wherein: for each location along the camera ray, the one or more processors are configured to apply a first Neural Radiance Field (NeRF) model to the location data to generate a feature vector for the location and first density data for the location; the one or more processors are configured to, as part of applying the static head of the trained ML model: apply a second NeRF model to the feature vector for the location and the first density data for the location to generate the static albedo data for the location; and apply a first multilayer perceptron (MLP) to the first density data for the location to generate the static normal vector for the location, and the one or more processors are configured to, as part of applying the transient head of the trained ML model: apply a third NeRF model to the feature vector for the location and the transient embedding to generate the transient albedo data for the location and the transient density data for the location; and apply a second MLP to the transient density data for the location to generate the transient normal vector for the location.

Clause 7. The system of any of clauses 1-6, wherein the trained ML model is trained based on images captured in daytime illumination conditions and the set of SH coefficients represent nighttime illumination conditions.

Clause 8. The system of any of clauses 1-7, wherein the one or more processors are further configured to use the relit image as training data for training a driver-assistance system.

Clause 9. A computer-implemented method comprising: generating rendered color data for a plurality of camera rays, wherein each of the camera rays is cast from a camera origin point in a respective direction, and generating the rendered color data comprises: for each location of a plurality of locations in a 3-dimensional scene along each camera ray of the plurality of camera rays: applying a static head of a trained machine learning (ML) model to location data to generate static output data for the location, wherein the location data indicates the location and the static output data for the location includes a static albedo data for the location in an absence of any transient objects at the location, a static density data for the location in the absence of any transient objects at the location, and a static normal vector for the location in the absence of any transient objects at the location; applying a transient head of the trained ML model to the location data and a transient embedding to generate transient output data for the location, wherein the transient output data for the location includes transient albedo data for the location at a specific point in time, transient density data for the location at the specific point in time, and a transient normal vector for the location at the specific point in time; applying a multilevel perceptron of the trained ML model to the location and a set of Spherical Harmonics (SH) coefficients to generate shadow data for the location, the set of SH coefficients representing target illumination conditions for a relit image; generating composite density data for the location based on the static density data for the location and the transient density data for the location; and generating composite albedo data for the location based on the static albedo data for the location, the transient albedo data for the location, the static density data for the location, the transient density data for the location, and the composite density data for the location; and generating the rendered color data for the camera ray based on the shadow data for the locations along the camera ray, the composite density data for the locations along the camera ray, the composite albedo data for the locations along the camera ray, the static or transient normal vectors for the locations along the camera ray, and the set of SH coefficients; and generating the relit image based on the rendered color data for the plurality of camera rays.

Clause 10. The computer-implemented method of clause 9, wherein generating the rendered color data for the camera ray comprises: calculating a transmittance value for the location based on the composite density data for the location and composite density data for previous locations along the camera ray and based on a distance between the locations along the camera ray; calculating shadow data for the camera ray based on the transmittance values for the locations along the camera ray and the shadow data for the locations along the camera ray; calculating a Spherical Harmonics basis based on the static normal vector and the transient normal vector; calculating preliminary color data for the camera ray based on the transmittance values for the locations along the camera ray, the composite albedo data for the locations along the camera ray, the set of SH coefficients, and the SH basis; and calculating the rendered color data for the camera ray based on the shadow data for the camera ray and the preliminary color data for the camera ray.

Clause 11. The computer-implemented method of clause 10, wherein calculating the preliminary color data for the camera ray comprises calculating the preliminary color data for the camera ray as a sum of elements corresponding to the locations along the camera ray, each of the elements being a Hadamard multiplication of transmittance-adjusted color data for the location corresponding to the element and a multiplication product of the set of SH coefficients and the SH basis, the transmittance-adjusted color data for the location corresponding to the element being based on the transmittance value for the location corresponding to the element and the composite albedo data for the location.

Clause 12. The computer-implemented method of any of clauses 10-11, wherein further comprising generating the rendered color data for the camera ray as a multiplication product of the shadow data for the camera ray and the preliminary color data for the camera ray.

Clause 13. The computer-implemented method of any of clauses 9-12, wherein the trained ML model has been trained using image data representative of the 3-dimensional scene.

Clause 14. The computer-implemented method of any of clauses 9-13, wherein: the method further comprises applying, for each location along the camera ray, a first Neural Radiance Field (NeRF) model to the location data to generate a feature vector for the location and first density data for the location, applying the static head of the trained ML model comprises: applying a second NeRF model to the feature vector for the location and the first density data for the location to generate the static albedo data for the location; and applying a first multilayer perceptron (MLP) to the first density data for the location to generate the static normal vector for the location, and the one or more processors are configured to, as part of applying the transient head of the trained ML model: applying a third NeRF model to the feature vector for the location and the transient embedding to generate the transient albedo data for the location and the transient density data for the location; and applying a second MLP to the transient density data for the location to generate the transient normal vector for the location.

Clause 15. The computer-implemented method of any of clauses 9-14, wherein the trained ML model is trained based on images captured in daytime illumination conditions and the set of SH coefficients represent nighttime illumination conditions.

Clause 16. A system comprising: a storage system configured to store a trained ML model; and one or more processors implemented in circuitry and coupled to the storage system, the one or more processors configured to: train a machine learning (ML) model to generate rendered color data for a camera ray, wherein the one or more processors are configured to, as part of training the ML model, for each training example of a plurality of training examples: generate rendered color data for a plurality of camera rays, wherein each of the camera rays is cast from a camera origin point associated with the training example in a respective direction associated with the training example, and the one or more processors are configured to, as part of generating the rendered color data: for each location of a plurality of locations in a 3-dimensional scene along each camera ray of the plurality of camera rays: apply a static head of the ML model to location data to generate static output data for the location, wherein the location data indicates the location and the static output data for the location includes a static albedo data for the location in an absence of any transient objects at the location, a static density data for the location in the absence of any transient objects at the location, and a static normal vector for the location in the absence of any transient objects at the location; apply a transient head of the ML model to the location data and a transient embedding to generate transient output data for the location, wherein the transient output data for the location includes transient albedo data for the location at a specific point in time associated with the training example, transient density data for the location at the specific point in time, and a transient normal vector for the location at the specific point in time; apply a multilevel perceptron of the ML model to the location and a set of Spherical Harmonics (SH) coefficients to generate shadow data for the location, the set of SH coefficients representing illumination conditions of a ground-truth image associated with the training example; generate composite density data for the location based on the static density data for the location and the transient density data for the location; and generate composite albedo data for the location based on the static albedo data for the location, the transient albedo data for the location, the static density data for the location, the transient density data for the location, and the composite density data for the location; and generate the rendered color data for the camera ray based on the shadow data for the locations along the camera ray, the composite density data for the locations along the camera ray, the composite albedo data for the locations along the camera ray, the static or transient normal vectors for the locations along the camera ray, and the set of SH coefficients; and generate a rendered image based on the rendered color data for the plurality of camera rays; apply a photometric loss based on the rendered color data for the plurality of camera rays and color data of the ground-truth image associated with the training example; and perform a backpropagation process that modifies parameters of the ML model based on the photometric loss.

Clause 17. The system of clause 16, wherein the one or more processors are configured to, as part of generating the rendered color data for the camera ray: calculate a transmittance value for the location based on the composite density data for the location and composite density data for previous locations along the camera ray and based on a distance between the locations along the camera ray; calculate shadow data for the camera ray based on the transmittance values for the locations along the camera ray and the shadow data for the locations along the camera ray; calculate a Spherical Harmonics basis based on the static normal vector and the transient normal vector; calculate preliminary color data for the camera ray based on the transmittance values for the locations along the camera ray, the composite albedo data for the locations along the camera ray, the set of SH coefficients, and the SH basis; and calculate the rendered color data for the camera ray based on the shadow data for the camera ray and the preliminary color data for the camera ray.

Clause 18. The system of clause 17, wherein the one or more processors are configured to, as part of calculating the preliminary color data for the camera ray, calculate the preliminary color data for the camera ray as a sum of elements corresponding to the locations along the camera ray, each of the elements being a Hadamard multiplication of transmittance-adjusted color data for the location corresponding to the element and a multiplication product of the set of SH coefficients and the SH basis, the transmittance-adjusted color data for the location corresponding to the element being based on the transmittance value for the location corresponding to the element and the composite albedo data for the location.

Clause 19. The system of any of clauses 17-18, wherein the one or more processors are configured to generate the rendered color data for the camera ray as a multiplication product of the shadow data for the camera ray and the preliminary color data for the camera ray.

Clause 20. The system of any of clauses 16-19, wherein: for each location along the camera ray, the one or more processors are configured to apply a first Neural Radiance Field (NeRF) model to the location data to generate a feature vector for the location and first density data for the location, the one or more processors are configured to, as part of applying the static head of the ML model: apply a second NeRF model to the feature vector for the location and the first density data for the location to generate the static albedo data for the location; and apply a first multilayer perceptron (MLP) to the first density data for the location to generate the static normal vector for the location, and the one or more processors are configured to, as part of applying the transient head of the ML model: apply a third NeRF model to the feature vector for the location and the transient embedding to generate the transient albedo data for the location and the transient density data for the location; and applying a second MLP to the transient density data for the location to generate the transient normal vector for the location.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of Ics (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A system comprising:
a storage system configured to store a trained machine learning (ML) model; and
a processing system comprising one or more processors implemented in circuitry and coupled to the storage system, the one or more processors configured to:
generate rendered color data for a plurality of camera rays, wherein each of the camera rays is cast from a camera origin point in a respective direction, and the one or more processors are configured to, as part of generating the rendered color data:
for each location of a plurality of locations in a 3-dimensional scene along each camera ray of the plurality of camera rays:
apply a static head of the trained ML model to location data to generate static output data for the location, wherein the location data indicates the location and the static output data for the location includes a static albedo data for the location in an absence of any transient objects at the location, a static density data for the location in the absence of any transient objects at the location, and a static normal vector for the location in the absence of any transient objects at the location;
apply a transient head of the trained ML model to the location data and a transient embedding to generate transient output data for transient objects at the location, wherein the transient output data for the location includes transient albedo data for the location at a specific point in time, transient density data for the location at the specific point in time, and a transient normal vector for the location at the specific point in time;
apply a multilevel perceptron of the trained ML model to the location data and a set of Spherical Harmonics (SH) coefficients to generate shadow data for the location, the set of SH coefficients representing target illumination conditions for a relit image;
generate composite density data for the location based on the static density data for the location and the transient density data for the location; and
generate composite albedo data for the location based on the static albedo data for the location, the transient albedo data for the location, the static density data for the location, the transient density data for the location, and the composite density data for the location; and
generate the rendered color data for the camera ray based on the shadow data for the locations along the camera ray, the composite density data for the locations along the camera ray, the composite albedo data for the locations along the camera ray, static or transient normal vectors for the locations along the camera ray, and the SH coefficients; and
generate the relit image based on the rendered color data for the plurality of camera rays.

2. The system of claim 1, wherein the one or more processors are configured to, as part of generating the rendered color data for the camera ray:
calculate a transmittance value for the location based on the composite density data for the location and composite density data for previous locations along the camera ray and based on a distance between the locations along the camera ray;
calculate shadow data for the camera ray based on the transmittance values for the locations along the camera ray and the shadow data for the locations along the camera ray;
calculate a SH basis based on the static normal vector and the transient normal vector;
calculate preliminary color data for the camera ray based on the transmittance values for the locations along the camera ray, the composite albedo data for the locations along the camera ray, the set of SH coefficients, and the SH basis; and
calculate the rendered color data for the camera ray based on the shadow data for the camera ray and the preliminary color data for the camera ray.

3. The system of claim 2, wherein the one or more processors are configured to, as part of calculating the preliminary color data for the camera ray, calculate the preliminary color data for the camera ray as a sum of elements corresponding to the locations along the camera ray, each of the elements being a Hadamard multiplication of transmittance-adjusted color data for the location corresponding to the element and a multiplication product of the set of SH coefficients and the SH basis, the transmittance-adjusted color data for the location corresponding to the element being based on the transmittance value for the location corresponding to the element and the composite albedo data for the location.

4. The system of claim 2, wherein the one or more processors are configured to generate the rendered color data for the camera ray as a multiplication product of the shadow data for the camera ray and the preliminary color data for the camera ray.

5. The system of claim 1, wherein the trained ML model has been trained using image data representative of the 3-dimensional scene.

6. The system of claim 1, wherein:
for each location along the camera ray, the one or more processors are configured to apply a first Neural Radiance Field (NeRF) model to the location data to generate a feature vector for the location and first density data for the location;
the one or more processors are configured to, as part of applying the static head of the trained ML model:
apply a second NeRF model to the feature vector for the location and the first density data for the location to generate the static albedo data for the location; and
apply a first multilayer perceptron (MLP) to the first density data for the location to generate the static normal vector for the location, and
the one or more processors are configured to, as part of applying the transient head of the trained ML model:
apply a third NeRF model to the feature vector for the location and the transient embedding to generate the transient albedo data for the location and the transient density data for the location; and
apply a second MLP to the transient density data for the location to generate the transient normal vector for the location.

7. The system of claim 1, wherein the trained ML model is trained based on images captured in daytime illumination conditions and the set of SH coefficients represent nighttime illumination conditions.

8. The system of claim 1, wherein the one or more processors are further configured to use the relit image as training data for training a driver-assistance system.

9. A computer-implemented method comprising:
generating rendered color data for a plurality of camera rays, wherein each of the camera rays is cast from a camera origin point in a respective direction, and generating the rendered color data comprises:
for each location of a plurality of locations in a 3-dimensional scene along each camera ray of the plurality of camera rays:
applying a static head of a trained machine learning (ML) model to location data to generate static output data for the location, wherein the location data indicates the location and the static output data for the location includes a static albedo data for the location in an absence of any transient objects at the location, a static density data for the location in the absence of any transient objects at the location, and a static normal vector for the location in the absence of any transient objects at the location;
applying a transient head of the trained ML model to the location data and a transient embedding to generate transient output data for the location, wherein the transient output data for the location includes transient albedo data for the location at a specific point in time, transient density data for the location at the specific point in time, and a transient normal vector for the location at the specific point in time;
applying a multilevel perceptron of the trained ML model to the location and a set of Spherical Harmonics (SH) coefficients to generate shadow data for the location, the set of SH coefficients representing target illumination conditions for a relit image;
generating composite density data for the location based on the static density data for the location and the transient density data for the location; and
generating composite albedo data for the location based on the static albedo data for the location, the transient albedo data for the location, the static density data for the location, the transient density data for the location, and the composite density data for the location; and
generating the rendered color data for the camera ray based on the shadow data for the locations along the camera ray, the composite density data for the locations along the camera ray, the composite albedo data for the locations along the camera ray, the static or transient normal vectors for the locations along the camera ray, and the set of SH coefficients; and
generating the relit image based on the rendered color data for the plurality of camera rays.

10. The computer-implemented method of claim 9, wherein generating the rendered color data for the camera ray comprises:
calculating a transmittance value for the location based on the composite density data for the location and composite density data for previous locations along the camera ray and based on a distance between the locations along the camera ray;
calculating shadow data for the camera ray based on the transmittance values for the locations along the camera ray and the shadow data for the locations along the camera ray;
calculating a Spherical Harmonics basis based on the static normal vector and the transient normal vector;
calculating preliminary color data for the camera ray based on the transmittance values for the locations along the camera ray, the composite albedo data for the locations along the camera ray, the set of SH coefficients, and the SH basis; and
calculating the rendered color data for the camera ray based on the shadow data for the camera ray and the preliminary color data for the camera ray.

11. The computer-implemented method of claim 10, wherein calculating the preliminary color data for the camera ray comprises calculating the preliminary color data for the camera ray as a sum of elements corresponding to the locations along the camera ray, each of the elements being a Hadamard multiplication of transmittance-adjusted color data for the location corresponding to the element and a multiplication product of the set of SH coefficients and the SH basis, the transmittance-adjusted color data for the location corresponding to the element being based on the transmittance value for the location corresponding to the element and the composite albedo data for the location.

12. The computer-implemented method of claim 10, wherein further comprising generating the rendered color data for the camera ray as a multiplication product of the shadow data for the camera ray and the preliminary color data for the camera ray.

13. The computer-implemented method of claim 9, wherein the trained ML model has been trained using image data representative of the 3-dimensional scene.

14. The computer-implemented method of claim 9, wherein:
the method further comprises applying, for each location along the camera ray, a first Neural Radiance Field (NeRF) model to the location data to generate a feature vector for the location and first density data for the location,
applying the static head of the trained ML model comprises:
applying a second NeRF model to the feature vector for the location and the first density data for the location to generate the static albedo data for the location; and
applying a first multilayer perceptron (MLP) to the first density data for the location to generate the static normal vector for the location, and applying the transient head of the trained ML model comprises:
applying a third NeRF model to the feature vector for the location and the transient embedding to generate the transient albedo data for the location and the transient density data for the location; and
applying a second MLP to the transient density data for the location to generate the transient normal vector for the location.

15. The computer-implemented method of claim 9, wherein the trained ML model is trained based on images captured in daytime illumination conditions and the set of SH coefficients represent nighttime illumination conditions.

16. A system comprising:
a storage system configured to store a trained ML model; and
one or more processors implemented in circuitry and coupled to the storage system, the one or more processors configured to:
train a machine learning (ML) model to generate rendered color data for a camera ray, wherein the one or more processors are configured to, as part of training the ML model, for each training example of a plurality of training examples:
generate rendered color data for a plurality of camera rays, wherein each of the camera rays is cast from a camera origin point associated with the training example in a respective direction associated with the training example, and the one or more processors are configured to, as part of generating the rendered color data:
for each location of a plurality of locations in a 3-dimensional scene along each camera ray of the plurality of camera rays:
apply a static head of the ML model to location data to generate static output data for the location, wherein the location data indicates the location and the static output data for the location includes a static albedo data for the location in an absence of any transient objects at the location, a static density data for the location in the absence of any transient objects at the location, and a static normal vector for the location in the absence of any transient objects at the location;
apply a transient head of the ML model to the location data and a transient embedding to generate transient output data for the location, wherein the transient output data for the location includes transient albedo data for the location at a specific point in time associated with the training example, transient density data for the location at the specific point in time, and a transient normal vector for the location at the specific point in time;
apply a multilevel perceptron of the ML model to the location and a set of Spherical Harmonics (SH) coefficients to generate shadow data for the location, the set of SH coefficients representing illumination conditions of a ground-truth image associated with the training example;
generate composite density data for the location based on the static density data for the location and the transient density data for the location; and
generate composite albedo data for the location based on the static albedo data for the location, the transient albedo data for the location, the static density data for the location, the transient density data for the location, and the composite density data for the location; and
generate the rendered color data for the camera ray based on the shadow data for the locations along the camera ray, the composite density data for the locations along the camera ray, the composite albedo data for the locations along the camera ray, the static or transient normal vectors for the locations along the camera ray, and the set of SH coefficients; and
generate a rendered image based on the rendered color data for the plurality of camera rays;
apply a photometric loss based on the rendered color data for the plurality of camera rays and color data of the ground-truth image associated with the training example; and
perform a backpropagation process that modifies parameters of the ML model based on the photometric loss.

17. The system of claim 16, wherein the one or more processors are configured to, as part of generating the rendered color data for the camera ray:
calculate a transmittance value for the location based on the composite density data for the location and composite density data for previous locations along the camera ray and based on a distance between the locations along the camera ray;
calculate shadow data for the camera ray based on the transmittance values for the locations along the camera ray and the shadow data for the locations along the camera ray;
calculate a Spherical Harmonics basis based on the static normal vector and the transient normal vector;
calculate preliminary color data for the camera ray based on the transmittance values for the locations along the camera ray, the composite albedo data for the locations along the camera ray, the set of SH coefficients, and the SH basis; and
calculate the rendered color data for the camera ray based on the shadow data for the camera ray and the preliminary color data for the camera ray.

18. The system of claim 17, wherein the one or more processors are configured to, as part of calculating the preliminary color data for the camera ray, calculate the preliminary color data for the camera ray as a sum of elements corresponding to the locations along the camera ray, each of the elements being a Hadamard multiplication of transmittance-adjusted color data for the location corresponding to the element and a multiplication product of the set of SH coefficients and the SH basis, the transmittance-adjusted color data for the location corresponding to the element being based on the transmittance value for the location corresponding to the element and the composite albedo data for the location.

19. The system of claim 17, wherein the one or more processors are configured to generate the rendered color data for the camera ray as a multiplication product of the shadow data for the camera ray and the preliminary color data for the camera ray.

20. The system of claim 16, wherein:
for each location along the camera ray, the one or more processors are configured to apply a first Neural Radiance Field (NeRF) model to the location data to generate a feature vector for the location and first density data for the location,
the one or more processors are configured to, as part of applying the static head of the ML model:
apply a second NeRF model to the feature vector for the location and the first density data for the location to generate the static albedo data for the location; and
apply a first multilayer perceptron (MLP) to the first density data for the location to generate the static normal vector for the location, and
the one or more processors are configured to, as part of applying the transient head of the ML model:
apply a third NeRF model to the feature vector for the location and the transient embedding to generate the transient albedo data for the location and the transient density data for the location; and
applying a second MLP to the transient density data for the location to generate the transient normal vector for the location.
